(19) United States
(12) Patent Application Publication
(10) Pub. No.: US 2016/0193962 A1
(43) Pub. Date: Jul. 7, 2016

(54) ANTI-GLARE REARVIEW MIRROR

(71) Applicant: Sky Mirror Co., Ltd., Taichung (TW)

(72) Inventor: Chien-Hung CHEN, Taichung (TW)

(21) Appl. No.: 14/958,228

(22) Filed: Dec. 3, 2015

(30) Foreign Application Priority Data
Jan. 6, 2015 (TW) 104100293

(51) Int. Cl. B60R 1/08; G02F 1/1334; G02F 1/1339; G02F 1/1335

(52) U.S. Cl. CPC B60R 1/088; G02F 1/133553; G02F 1/1334; G02F 1/13394; G02F 1/1339; G02F 2001/13398

(57) ABSTRACT

An anti-glare rearview mirror is provided, including a conductive reflection layer, being electrically conductive and having a reflection face; a polymer dispersed liquid crystal (PDLC) layer, positioned on a side of the reflection face and disposed on the conductive reflection layer, including a plurality of spacers, a radial dimension of the spacer being between 2 μm and 18 μm; a first transparent conductive oxide (TCO) layer, disposed on the PDLC layer; a transparent substrate, disposed on the first transparent conductive oxide layer; a side-sealing member, disposed around the PDLC layer to seal the PDLC layer between the conductive reflection layer and the first transparent conductive oxide layer; wherein at least part of the spacers abut against between the conductive reflection layer and the first transparent conductive oxide layer.

### BACKGROUND OF THE INVENTION

1. Field of the Invention

The present invention relates to a rearview mirror, and more particularly to an anti-glare rearview mirror.

2. Description of the Prior Art

Nowadays, an automobile has become the most important traffic tool. When strong lights from automobiles behind or exterior environment enter a rearview mirror of the automobile a user drives, the user will be dazzled by a glare reflected from the rearview mirror when seeing the rearview mirror. Therefore, more and more users mount anti-glare rearview mirrors in their automobiles.

As the number of automobile is increasing, the driving environment is worsening. When driving under strong sunlight, the rearview mirror reflects strong lights, and a driver may be dazzled and unable to see the road clearly; or when driving at night or in an environment where light is weak, the strong lights from the automobiles behind enter the rearview mirror, and the driver may be dazzled and unable to see the road clearly. To obviate the disadvantage, various types of anti-glare rearview mirror modules are provided.

Conventional anti-glare rearview mirrors are disclosed in TWM309528, TW533153 and TWI265972. The conventional anti-glare rearview mirrors control lights through an electrochromic material or an electrolyte layer, so the conventional anti-glare rearview mirrors have higher manufacturing costs and need longer reaction time (about 6 to 7 seconds or longer).

The present invention has arisen to mitigate and/or obviate the afore-described disadvantages.

### SUMMARY OF THE INVENTION

The major object of the present invention is to provide an anti-glare rearview mirror, wherein a reflection effect can be adjusted in accordance with an intensity of a light to effectively reduce reflected glare. A thickness and a driving electronic potential of the anti-glare rearview mirror largely decrease, so the anti-glare rearview mirror is easier to be driven and is energy-saving. In addition, the anti-glare rearview mirror can be driven by a square-wave alternating current to reduce glare.

To achieve the above and other objects, an anti-glare rearview mirror is provided, including: a conductive reflection layer, being electrically conductive and having a reflection face; a polymer dispersed liquid crystal (PDLC) layer, positioned on a side of the reflection face and disposed on the conductive reflection layer, including a plurality of spacers, a radial dimension of the spacer being between 2 μm and 18 μm; a first transparent conductive oxide (TCO) layer, disposed on the PDLC layer; a transparent substrate, disposed on the first transparent conductive oxide layer; a side-sealing member, disposed around the PDLC layer to seal the PDLC layer between the conductive reflection layer and the first transparent conductive oxide layer; wherein at least part of the spacers abut against between the conduction reflection layer and the first transparent conductive oxide layer.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a preferred embodiment of the present invention;

FIG. 2 is a cross-sectional view of the preferred embodiment of the present invention;

FIGS. 3 and 4 are drawings showing operation of the preferred embodiment of the present invention;

FIG. 5 is a drawing showing an alternating current circuit of the preferred embodiment of the present invention; and

FIG. 6 is a drawing showing an oscillogram of an alternating current of the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

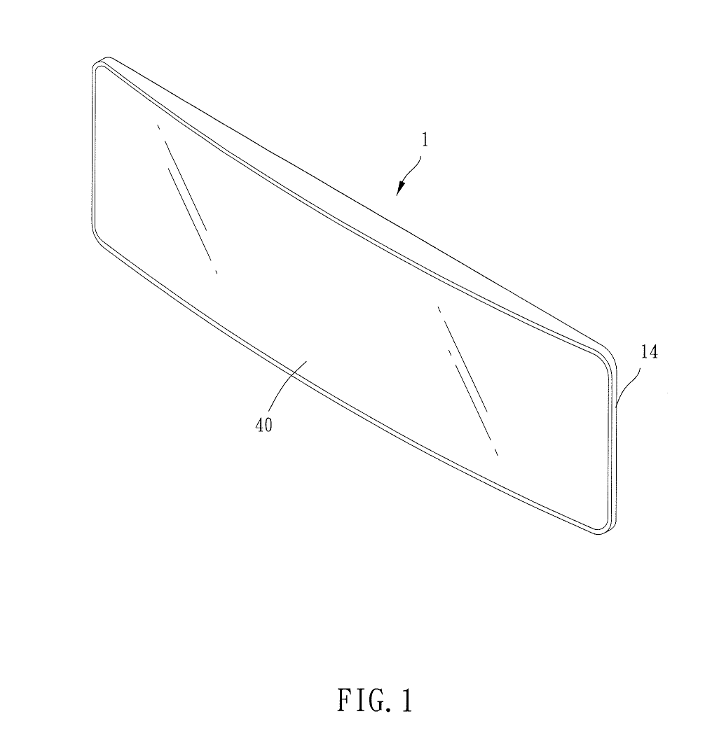

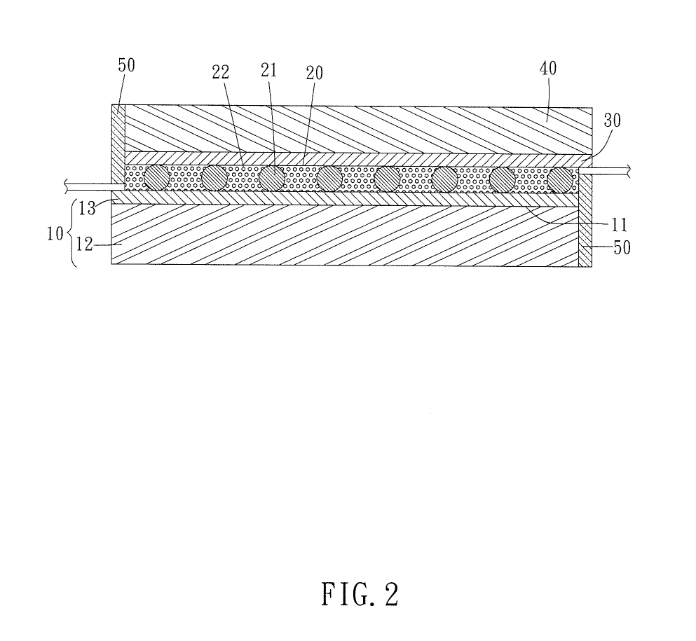

Please refer to FIGS. 1 to 4 for a preferred embodiment of the present invention. An anti-glare rearview mirror 1 includes a conductive reflection layer 10, a polymer dispersed liquid crystal (PDLC) layer 20, a first transparent conductive oxide layer 30, a transparent substrate 40 and a side-sealing member 50.

The conductive reflection layer 10 is electrically conductive and has a reflection face 11 for reflecting lights. In this embodiment, the conductive reflection layer 10 includes a metal sheet 12 and a second transparent conductive oxide layer 13. A side of the metal sheet 12 is provided with the reflection face 11, the second transparent conductive oxide layer 13 is disposed on the reflection face 11, the metal sheet 12 may be, for example, an aluminum sheet, and of course, the conductive reflection layer 10 may be a single integrally-formed conductive layer with the reflection face 11 formed (for example, polished) on a surface thereof. A side of the conductive reflection layer 10 opposite to the reflection face 11 may be further provided with a back board 14, and for example, the conductive reflection layer 10 may be disposed on a substrate such as a glass substrate to obtain preferable support and carrying capacity.

The PDLC layer 20 is positioned on a side of the reflection face 11 and disposed on the conductive reflection layer 10, and the PDLC layer 20 includes a plurality of spacers 21. The spacer 21 may be a ceramic particle or a plastic (for example, PS) particle, and a radial dimension of the spacer 21 is between 2 μm and 18 μm, and preferably between 5 μm and 10 μm. In the PDLC layer 20, the spacer 21 accounts for 0.4% to 2.0%, and preferably 0.4% to 0.5%; however, the dimension and percentage of the spacer may change in accordance with different requirements. A thickness of the PDLC layer 20 and a driving electronic potential the PDLC layer 20 needs are in positive correlation. For example, when the thickness of the PDLC layer 20 is 20 μm, the driving electronic potential is about 65 voltage; and when the thickness of the PDLC layer 20 is 5 μm to 8 μm, the driving electronic potential is about 18 voltage. It is to be noted that if a percentage of the spacer 21 is too low, substances in the PDLC layer 20 may be attributed unevenly; and if the percentage of the spacer 21 is too high, a light transmissibility of the PDLC layer 20 may be influenced.

The first transparent conductive oxide layer 30 is disposed on the PDLC layer 20, wherein the first transparent conductive oxide layer 30 or/and the second transparent conductive oxide layer 13 may be a film made of indium tin oxide (ITO), indium zinc oxide (IZO) or Al-doped ZnO (AZO). Preferably, each of the first transparent conductive oxide layer 30 and the conductive reflection layer 10 is shiftedly arranged relative to the PDLC layer 20 and partially exposed; therefore, it is convenient for the first transparent conductive oxide layer 30 and the conductive reflection layer 10 to be electrically connected with (for example, attached to, welded with or stuck with) an exterior power without damaging the first and second transparent conductive oxide layers 30, 13 which are pretty thin.

The transparent substrate 40 is disposed on the first transparent conductive oxide layer 30, and the transparent substrate 40 may be a glass substrate, a PET substrate or other similar substrates, wherein the PET substrate has sealing and protecting effects, and the PET substrate is low-cost and easy to be manufactured and is thin.

The side-sealing member 50 is disposed around the PDLC layer 20 to seal the PDLC layer 20 between the conductive reflection layer 10 and the first transparent conductive oxide layer 30. Because the PDLC layer 20 includes liquid crystal 22 which has low flowability, the side-sealing member 50 is disposed to prevent the liquid crystal 22 and ingredients in an upper portion of the PDLC layer 20 from flowing downwardly due to gravity and prevent an upper portion of the anti-glare rearview mirror 1 from losing function. The side-sealing member 50 may be any adhesive, for example, a UV glue or an epoxy glue. A least part of the spacers 21 abut against between the conductive reflection layer 10 and the first transparent conductive oxide layer 30 so as to precisely control a distance between the conductive reflection layer 10 and the first transparent conductive oxide layer 30 and to control the thickness of the PDLC layer 20 to be between 2 μm and 18 μm. Therefore, compared with a conventional structure, the thickness and the driving electronic potential largely decrease.

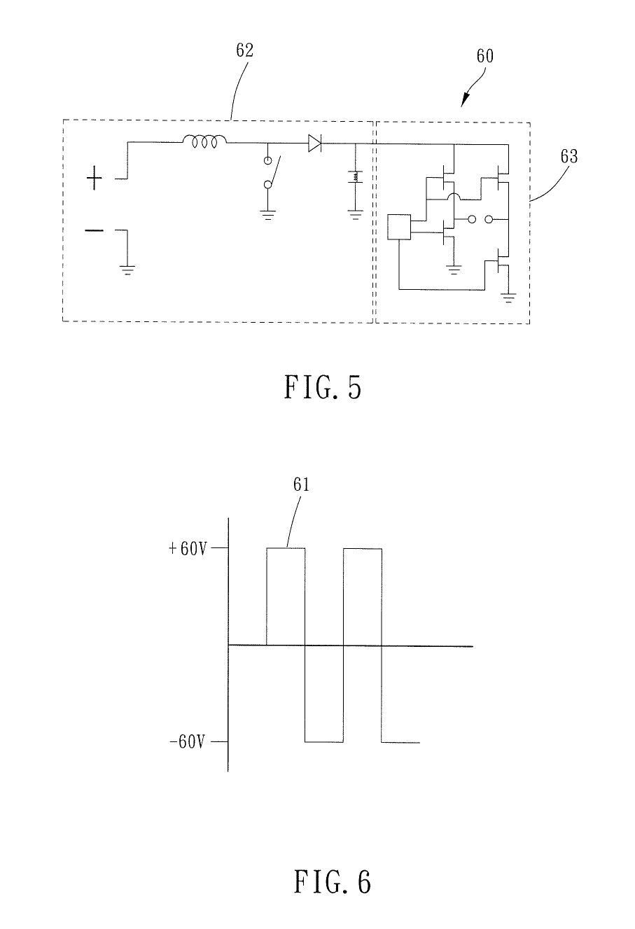

Please further refer to FIGS. 5 and 6. In this embodiment, the anti-glare rearview mirror 1 further includes an alternating current circuit 60, the alternating current circuit 60 is electrically connected with the first and second transparent conductive oxide layers 30, 13 of the conductive reflection layer 10, and the alternating current circuit 60 is for producing a square-wave alternating current 61 to be supplied to the conductive reflection layer 10 and the first transparent conductive oxide layer 30. Specifically, the alternating current circuit 60 includes a boosting circuit 62 and a DC-to-AC conversion circuit 63, a direct current which is, for example, 12 voltage is boosted to 60 voltage through the boosting circuit 62 and converted into an alternating current through the DC-to-AC conversion circuit 63.

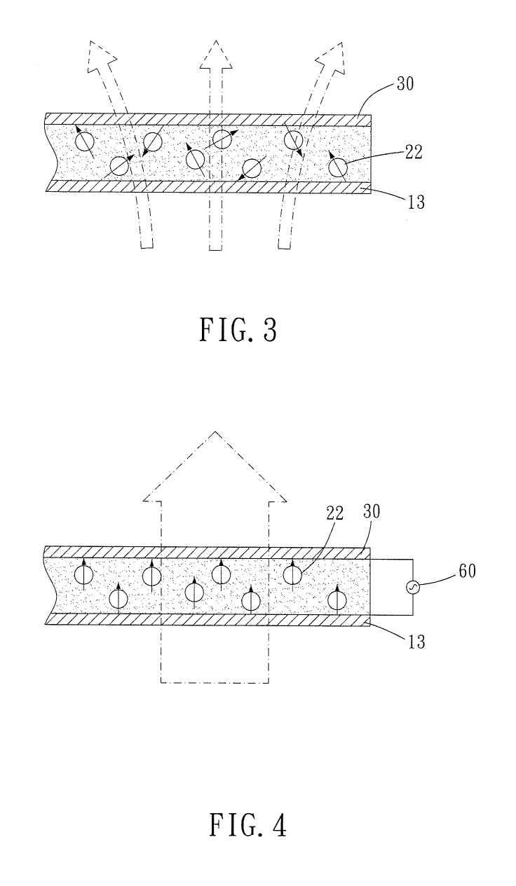

In actual operation, when a power of the alternating current circuit 60 is not conducted to the conductive reflection layer 10 and the first transparent conductive oxide layer 30, the liquid crystal 22 in the PDLC layer 20 is not affected by an electric field and does not rotate toward a same direction (as shown in FIG. 3), and incident/reflective lights will be scattered; therefore, after a strong light is reflected through the anti-glare rearview mirror 1, an intensity of the strong light is lower, and glare reflected reduces. When the power of the alternating current circuit 60 is conducted to the conductive reflection layer 10 and the first transparent conductive oxide layer 30, the liquid crystal 22 in the PDLC layer 20 is affected by the electric field and rotates toward the same direction (as shown in FIG. 4), and all incident/reflective lights are allowed to pass; therefore, weaker lights have greater reflection effects to maintain a preferable reflection effect of the anti-glare rearview mirror 1. It is to be noted that the alternating current circuit 60 produces the square-wave alternating current 61. Compared with an anti-glare rearview mirror using a sinusoidal-wave alternating current, the electronic potential quickly switches between +60 voltage and −60 voltage, for example, the liquid crystal 22 in the PDLC layer 20 is affected by the electric field and rotates toward the same direction, and the liquid crystal 22 continues to be toward the same direction and does not rotate to an original position while the sinusoidal-wave alternating current changes continuously gradually between a positive electric potential and a negative electric potential and is unable to keep the liquid crystal 22 being toward the same direction. Therefore, the anti-glare rearview mirror 1 using the square-wave alternating current has preferable light transmissibility and reflection effect and does not have problems of delay or superimposition. The reflection effect can be changed through, for example, an automatic light-sensing and controlling circuit.

Given the above, the anti-glare rearview mirror can adjust the reflection effect according to the intensity of the light and reduce the glare reflected effectively.

In addition, the spacers in the PDLC layer can precisely control the thickness of the PDLC layer to be between 2 μm and 18 μm to decrease the thickness and the driving electric potential largely. Therefore, the anti-glare rearview mirror is easier to be driven and is more energy-saving.

Furthermore, preferably, the anti-glare rearview mirror can be driven by the square-wave alternating current to maintain the light transmissibility and reflection effect of the anti-glare rearview mirror and prevent the problem of delay or superimposition. Therefore, the safety of driving is largely improved.

While we have shown and described various embodiments in accordance with the present invention, it should be clear to those skilled in the art that further embodiments may be made without departing from the scope of the present invention.

What is claimed is:

1. An anti-glare rearview mirror, including:
a conductive reflection layer, being electrically conductive and having a reflection face;
a polymer dispersed liquid crystal (PDLC) layer, positioned on a side of the reflection face and disposed on the conductive reflection layer, including a plurality of spacers, a radial dimension of the spacer being between 2 μm and 18 μm;
a first transparent conductive oxide (TCO) layer, disposed on the PDLC layer;
a transparent substrate, disposed on the first transparent conductive oxide layer;
a side-sealing member, disposed around the PDLC layer to seal the PDLC layer between the conduction reflection layer and the first transparent conductive oxide layer;
wherein at least part of the spacers abut against between the conductive reflection layer and the first transparent conductive oxide layer.

2. The anti-glare rearview mirror of claim 1, wherein each of the conductive reflection layer and the first transparent conductive oxide layer is shiftedly arranged relative to the PDLC layer and partially exposed.

3. The anti-glare rearview mirror of claim 1, wherein the conductive reflection layer includes a metal sheet and a second transparent conductive oxide layer, a side of the metal sheet is provided with the reflection face, and the second transparent conductive oxide layer is disposed on the reflection face.

4. The anti-glare rearview mirror of claim 3, wherein the metal sheet is an aluminum sheet.

5. The anti-glare rearview mirror of claim 1, wherein the first transparent conductive oxide layer is a film made of indium tin oxide (ITO), indium zinc oxide (IZO) or Al-doped ZnO (AZO).

6. The anti-glare rearview mirror of claim 1, wherein the radial dimension of the spacer is between 5 μm and 10 μm.

7. The anti-glare rearview mirror of claim 1, wherein in the PDLC layer, the spacer accounts for 0.4% to 2.0%.

8. The anti-glare rearview mirror of claim 1, wherein a side of the conductive reflection layer opposite to the reflection face is further provided with a back board.

9. The anti-glare rearview mirror of claim 1, wherein the transparent substrate is a glass or PET substrate.

10. The anti-glare rearview mirror of claim 1, further including an alternating current circuit, the alternating current circuit electrically connected with the conductive reflection layer and the first transparent conductive oxide layer, the alternating current circuit being for producing a square-wave alternating current to be supplied to the conductive reflection layer and the first transparent conductive oxide layer.
